(19) United States
(12) Patent Application Publication
(10) Pub. No.: US 2019/0279178 A1
(43) Pub. Date: Sep. 12, 2019

(54) SYSTEMS, METHODS AND COMPUTER PROGRAM PRODUCTS FOR AUTOMATED BILL PAYMENT

(71) Applicant: MASTERCARD INTERNATIONAL INCORPORATED, Purchase, NY (US)

(72) Inventors: Ashutosh Kumar GUPTA, Varanasi (IN); Ashutosh SHARAN, Gurgaon (IN); Yatin KATYAL, Rohtak (IN)

(21) Appl. No.: 16/299,288

(22) Filed: Mar. 12, 2019

(30) Foreign Application Priority Data
Mar. 12, 2018 (IN) 201811008995

(51) Int. Cl. G06Q 20/14; G06Q 20/40; G06F 17/27

(52) U.S. Cl. CPC G06Q 20/14; G06F 17/2705; G06Q 20/405

(57) ABSTRACT

The invention provides systems, methods and computer program products for automated electronic payments in connection with goods or services received from one or more merchants. In an embodiment, the invention enables generation of a payment authorization decision in connection with an automated bill payment, wherein said payment authorization decision is based on a determined variance between (i) an estimate of charges derived from update related data notifications received by a user and (ii) charges identified in a bill received from the merchant. In another embodiment, the invention enables updating an enrollment state of a merchant that has been previously enrolled for automated bill payments by a user, wherein said update is implemented responsive to detecting a change in state of a contract between a user and a merchant, and wherein said change in state is detected based on update related data notifications received by a user.

### CROSS-REFERENCE TO RELATED APPLICATIONS

This application claims priority to Indian Patent Application No. 201811008995 filed on Mar. 12, 2018, which is hereby incorporated by reference in its entirety.

### FIELD OF THE INVENTION

The present invention relates to electronic payment transactions. In particular, the invention provides systems, methods and computer program products for automated electronic payments in connection with goods or services received from one or more merchants.

### BACKGROUND

Automated bill payment services enable electronic payment of customer bills that are of a recurring or periodic nature—wherein funds are electronically transferred to a merchant on receipt of a statement of charges or at the end of a defined billing cycle—without a specific or direct instruction from the customer.

Despite the convenience, customers remain skeptical of adopting such services for multiple reasons. One particular area of concern is that authorizing automated payments of bills may result in the customer being charged for fraudulent transactions or for goods or services that have not been supplied or consumed. Another particular concern is that once a merchant has been approved for automated bill payments, automated bill payments to such merchant may inadvertently continue despite subsequent termination of the contractual arrangement with the merchant.

There is accordingly a need for verification or validation of charges levied by a merchant on a customer, as a pre-condition to authorizing an automated payment of bills raised by the merchant. Additionally, there is a requirement for safeguards to ensure that automated payments to a merchant are modified, terminated or suspended in response to modification, termination or suspension of the contractual arrangement for supply of goods or services by such merchant.

### SUMMARY

The present invention relates to automated electronic payments in connection with goods or services received from one or more merchants.

The invention provides a method for automated payment of bills. The method comprises (i) parsing one or more data notifications received by a user from a merchant that has been enrolled by the user for automated bill payment, (ii) extracting from the parsed data notifications, data describing goods or services provided by the merchant to the user, (iii) generating an estimate of charges based on the extracted data; (iv) receiving a bill of charges from the merchant, (iv) determining a variance between the generated estimate of charges and charges identified in a bill received from the merchant, and (v) generating a payment authorization decision corresponding to the bill received from the merchant, wherein the payment authorization decision is based on the determined variance.

In an embodiment, responsive to the determined variance falling within a defined variance threshold, the payment authorization decision comprises a decision to initiate payment of a due amount identified within the bill received from the merchant.

In another embodiment, responsive to the determined variance falling outside a defined variance threshold, the payment authorization decision comprises a decision to decline payment of a due amount identified within the bill received from the merchant.

In a particular embodiment, responsive to the determined variance falling outside a defined variance threshold, the payment authorization decision comprises a decision to transmit a request for payment authorization to the user.

The invention additionally provides a method for updating an enrollment state of a merchant that has been enrolled for automated bill payments by a user. The method comprises (i) parsing one or more data notifications received by the user from the merchant, (ii) extracting from the parsed data notifications, data describing a present state of a contract for goods or services between the user and the merchant, (iii) analyzing the extracted data for detecting a change in state of the contract, wherein detection of change in state is based on comparing a detected present state of the contract with an earlier identified state of the contract, and (iv) responsive to detecting a change in state of the contract, generating an instruction to update a state of the merchant's enrollment for automated bill payments.

In a method embodiment, responsive to the detected change in state of the contract comprising a modification to the state of the contract, the generated instruction to update a state of the merchant's enrollment for automated bill payments comprises an instruction to modify said state of the merchant's enrollment for automated bill payments.

In another method embodiment, responsive to the detected change in state of the contract comprising suspension of the contract, the generated instruction to update a state of the merchant's enrollment for automated bill payments comprises an instruction to suspend the merchant's enrollment for automated bill payments.

In a particular method embodiment, responsive to the detected change in state of the contract comprising termination of the contract, the generated instruction to update a state of the merchant's enrollment for automated bill payments comprises an instruction to terminate the merchant's enrollment for automated bill payments.

In an embodiment, attributes of the generated instruction to update a state of the merchant's enrollment for automated bill payments are based on (i) one or more predefined rules regarding generation of instructions for modification, suspension or termination of prior instructions for automated bill payment or (ii) the attributes of the detected change of state of the merchant's enrollment for automated bill payments.

The invention further provides a computer implemented system for automated payment of bills. The system comprises a processor configured to (i) parse one or more data notifications received by a user from a merchant that has been enrolled by the user for automated bill payment, (ii) extract from the parsed data notifications, data describing goods or services provided by the merchant to the user, (iii) generate an estimate of charges based on the extracted data; (iv) receive a bill of charges from the merchant, (v) determine a variance between the generated estimate of charges and charges identified in a bill received from the merchant, and (vi) generate a payment authorization decision corresponding to the bill received from the merchant, wherein the payment authorization decision is based on the determined variance.

In an embodiment, the processor is configured such that, responsive to the determined variance falling within a defined variance threshold, the payment authorization decision comprises a decision to initiate payment of a due amount identified within the bill received from the merchant.

In another embodiment, the processor is configured such that, responsive to the determined variance falling outside a defined variance threshold, the payment authorization decision comprises a decision to decline payment of a due amount identified within the bill received from the merchant.

In a particular embodiment, the processor is configured such that responsive to the determined variance falling outside a defined variance threshold, the payment authorization decision comprises a decision to transmit a request for payment authorization to the user.

The invention additionally provides a computer implemented system for updating an enrollment state of a merchant that has been enrolled for automated bill payments by a user. The system comprises a processor configured to (i) parse one or more data notifications received by the user from the merchant, (ii) extract from the parsed data notifications, data describing a present state of a contract for goods or services between the user and the merchant, (iii) analyze the extracted data for detecting a change in state of the contract, wherein detection of change in state is based on comparing a detected present state of the contract with an earlier identified state of the contract, and (iv) responsive to detecting a change in state of the contract, generate an instruction to update a state of the merchant's enrollment for automated bill payments.

In a system embodiment, the processor is configured such that, responsive to the detected change in state of the contract comprising a modification to the state of the contract, the generated instruction to update a state of the merchant's enrollment for automated bill payments comprises an instruction to modify said state of the merchant's enrollment for automated bill payments.

In another system embodiment, the processor is configured such that, responsive to the detected change in state of the contract comprising suspension of the contract, the generated instruction to update a state of the merchant's enrollment for automated bill payments comprises an instruction to suspend the merchant's enrollment for automated bill payments.

In a particular system embodiment, the processor is configured such that, responsive to the detected change in state of the contract comprising termination of the contract, the generated instruction to update a state of the merchant's enrollment for automated bill payments comprises an instruction to terminate the merchant's enrollment for automated bill payments.

In an embodiment, the processor is configured such that, attributes of the generated instruction to update a state of the merchant's enrollment for automated bill payments are based on (i) one or more predefined rules regarding generation of instructions for modification, suspension or termination of prior instructions for automated bill payment, or (ii) the attributes of the detected change of state of the merchant's enrollment for automated bill payments.

The invention additionally provides a computer program product for automated payment of bills. The computer program product comprises a non-transitory computer readable medium having a computer readable program code embodiment therein, the computer readable program code comprising instructions for (i) parsing one or more data notifications received by a user from a merchant that has been enrolled by the user for automated bill payment, (ii) extracting from the parsed data notifications, data describing goods or services provided by the merchant to the user, (iii) generating an estimate of charges based on the extracted data, (iv) receiving a bill of charges from the merchant, (v) determining a variance between the generated estimate of charges and charges identified in a bill received from the merchant, and (vi) generating a payment authorization decision corresponding to the bill received from the merchant, wherein the payment authorization decision is based on the determined variance.

The invention further provides a computer program product for updating an enrollment state of a merchant that has been enrolled for automated bill payments by a user. The computer program product comprises a non-transitory computer readable medium having a computer readable program code embodiment therein, the computer readable program code comprising instructions for (i) parsing one or more data notifications received by the user from the merchant, (ii) extracting from the parsed data notifications, data describing a present state of a contract for goods or services between the user and the merchant, (iii) analyzing the extracted data for detecting a change in state of the contract, wherein detection of change in state is based on comparing a detected present state of the contract with an earlier identified state of the contract, and (iv) responsive to detecting a change in state of the contract, generating an instruction to update a state of the merchant's enrollment for automated bill payments.

### BRIEF DESCRIPTION OF THE ACCOMPANY DRAWINGS

FIG. 1 illustrates a system capable of implementing the present invention.

FIG. 2 illustrates a method of automated bill payment.

FIG. 3 illustrates a method of verifying charges levied by a merchant prior to authorizing automated electronic payment to such merchant, in accordance with the present invention.

FIGS. 4 and 5 illustrate specific embodiments of the step of generating a payment authorization decision in accordance with the teachings of the method more generally discussed in connection with FIG. 3.

FIG. 6 illustrates a method of modifying, suspending or terminating automated bill payments from a user to a merchant, in accordance with teachings of the present invention.

FIG. 7 illustrates an exemplary computer system according to which various embodiments of the present invention may be implemented.

### DETAILED DESCRIPTION OF THE INVENTION

The invention provides methods, systems and computer programs for implementing automated bill payments on behalf of a user, from a payment institution to one or more merchants. In particular, the invention enables verification of charges levied by a merchant prior to authorizing automated payment of the merchant charges. The invention additionally provides safeguards to ensure that automated payments to a merchant can be modified, terminated or suspended in response to modification, termination or suspension of the merchant's contract for providing goods or services to a user.

For the purposes of the present invention, the following terms shall be understood to have the corresponding meanings provided below, in addition to plain and dictionary meanings thereof.

“Bill” shall mean include any bill, invoice, debit note or statement of charges that is issued by a merchant or service provider for goods or services provided to a user.

“Merchant” shall mean any individual or entity that offers or provides goods or services in exchange for payment.

“Network” shall refer to any communication network communicatively disposed between any two or more of a user device, user payment account, a payment institution, and a merchant payment account.

“Payment account” shall mean any account that may be used for the purposes of making or receiving an electronic payment or electronic transaction, and shall include any electronic transaction account, payment card account, bank account or electronic wallet account.

“Payment card” shall mean a card or data associated with a payment account to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

“User” shall mean any receiver of goods or services from a merchant or service provider, who has instructed or intends to instruct a payment institution to make automated bill payments on the user's behalf to the merchant or service provider.

“User Device” shall mean any processor implemented device having network communication capabilities, and includes without limitation any network communication enabled computing device or mobile communication device.

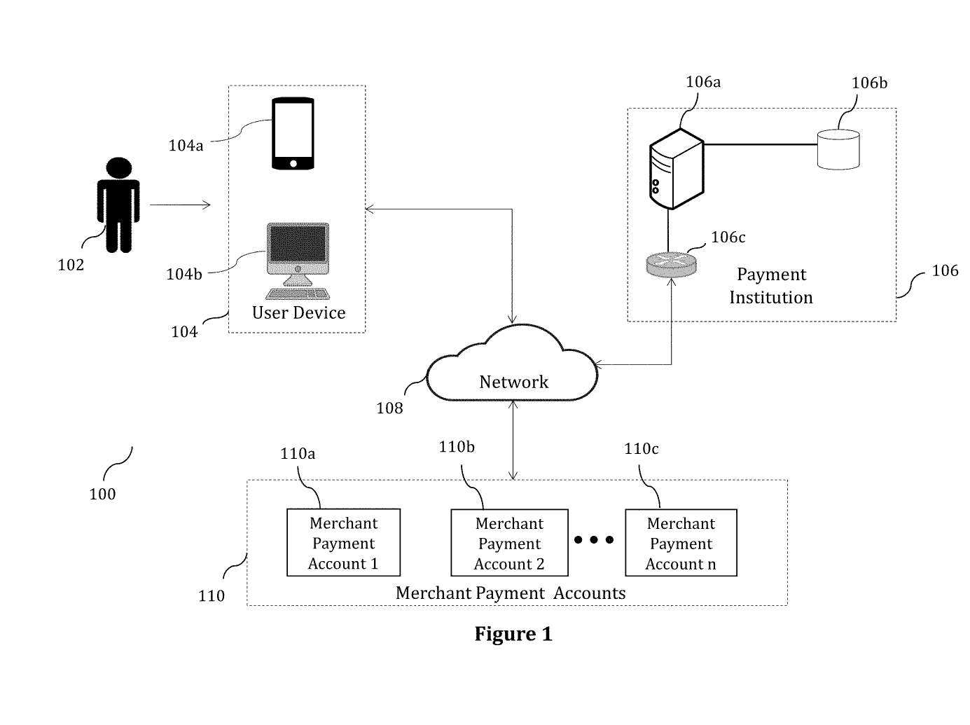

FIG. 1 illustrates a system 100 that may be particularly configured for automated bill payments on behalf of a user, through a payment institution, to one or more merchants or to one or more merchant payment accounts. Effecting automated bill payments involves electronic payments made by way of a payment card or payment account associated with a user 102—which payment card or payment account have been issued to the user by a payment institution 106 (for example, a bank, credit card company, or electronic payment service such as Western Union, PayPal etc.).

System 100 may include user device 104 (which may in turn comprise either of user devices 104a or 104b), payment institution 106, network 108 and one or more merchant accounts 110 (shown in FIG. 1 as merchant accounts 1 to n). A user 102 has access to corresponding user device(s) 104a and 104b, which user device(s) 104a, 104b may in an embodiment comprise one or more processor enabled devices having wireless communication capability and/or network communication capability, and in more specific embodiments may include any of a mobile communication device 104a and a processor enabled client terminal 104b (for example, a desktop, laptop or other personal computing device having network communication capabilities).

In the system of FIG. 1, user 102 may seek to enable automated bill payments to a merchant through a payment card or payment account that has been issued to said user 102 by payment institution 106. Payment institution 106 may be configured for network communication with user device(s) 104a, 104b on one side, and with one or more merchant accounts 110 on the other side—and in an embodiment, such network communication may be carried out over network 108.

Payment institution 106 may comprise payment institution server 106a, payment institution database 106b and payment institution interface gateway 106c.

Payment institution server 106a may be configured to receive and process information and actions relating to electronic payment transactions that are implemented through payment institution 106.

Payment institution database 106b may be configured to store information corresponding to users having payment cards or payment accounts issued by said payment institution 106, information corresponding to the payment cards or payment accounts issued by the payment institution 106, and additionally, information regarding merchants and merchant accounts that a particular user may have approved or registered with payment institution 106 for automated bill payments.

Payment institution interface gateway 106c may include a hardware or software network gateway configured to enable payment institution 106 to communicate with user devices 104, with merchant accounts 110, either directly or through network 108.

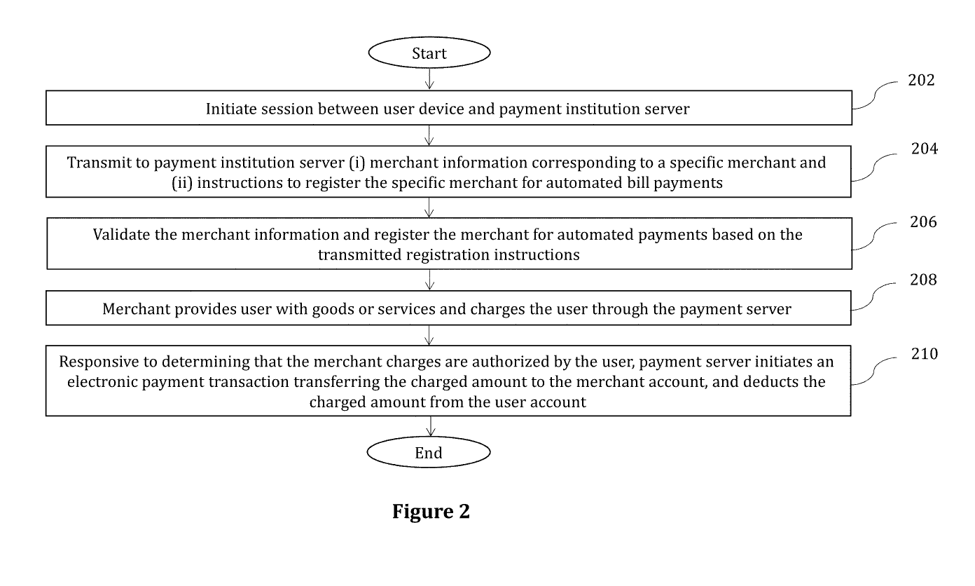

An implementation of a method for automated bill payments within system 100 of FIG. 1 is illustrated in the flowchart of FIG. 2.

Step 202 comprises initiating a communication session between any of user devices 104a, 104b and payment institution 106. It would be understood that in implementation, the communication session may be initiated between any of user devices 104a, 104b and payment institution server 106a, through payment institution interface gateway 106c. In an embodiment, initiation of the communication session between a user device 104a, 104b and payment institution 106 may be preceded by an authentication step involving authentication of identity of a user 102 as a precondition to allowing access to the user's payment account maintained with payment institution 106. For example, initiating the session may involve the user 102 logging into his/her online account maintained with payment institution 106. In an exemplary embodiment, logging into the user's online account may require the user to authenticate his/her identity using a user name, a passcode, a cookie, a biometric identifier, a private key, a token, and/or another authentication mechanism that is submitted by the user 102 to the payment institution server 106a by means of the user device 104a, 104b that is being used for the purpose of logging in.

Step 204 comprises transmitting to the payment institution server 106a, merchant information corresponding to a specific merchant, along with instructions to register the specific merchant for automated bill payments. In an embodiment, the merchant information and instructions to register the merchant for automated bill payments may be transmitted from user device 104a, 104b. It would be understood that the merchant information corresponding to a specific merchant (i) may be received at the user device 104a, 104b for onward transmission, based on user inputs through an interface provided by user device 104a, 104b, or (ii) may be selected and retrieved from a data repository or webpage link corresponding to the specific merchant—which repository or webpage link may be selected based on user inputs received through the user device 104a, 104b. In an embodiment, the transmitted merchant information may include one or more of a (i) merchant identifier, (ii) information identifying a merchant payment account corresponding to the merchant—for example, name and address of the bank or payment institution with which the merchant payment account is maintained, merchant payment account identifier, and/or any other information that may be necessary for the payment institution to effect an electronic payment to the merchant payment account, (iii) any applicable payment restrictions or specific payment instructions, such as payment caps or maximum permissible payments associated with the merchant, time period within which payments to the merchant payment account is permissible, number of permissible payments within a specified period of time etc., and (iv) payment events or payment triggers, responsive to which the payment institution is authorized to electronically credit a payment from the user's payment account to the merchant's payment account.

Step 206 comprises validating the received merchant information. Responsive to successful validation of the received merchant information, the selected merchant is registered by payment institution 106 for automated bill payments. In an embodiment of the invention, validating the received merchant information comprises parsing the received merchant information and ascertaining (i) that all information required to process an electronic payment to a merchant account has been received, (ii) that the merchant's payment account number and/or payment account information has been received in the correct format, and/or (iii) that there are no discernable errors in the merchant information received. Responsive to successful validation of the received merchant information, the selected merchant is registered with payment institution 106 for automated bill payments in accordance with any accompanying payment instructions that are received from the user 102 along with the instructions for registering the merchant.

It would be understood that the step of registering the selected merchant for automated bill payments may include the step of non-transitorily storing some or all of the received merchant information in payment institution database 106b, along with the user's instructions authorizing automated payment of bills corresponding to the registered merchant. In an embodiment, the step of storing some or all of the received merchant information in payment institution database 106b may include storing any one or more of (i) a merchant identifier corresponding to the merchant, (ii) information identifying a merchant payment account corresponding to the merchant, (iii) applicable payment restrictions, such as payment caps or maximum permissible payments associated with the merchant, payment windows, number of permissible payments within a specific period of time etc., and (iv) payment events or payment triggers, responsive to which the payment institution would electronically credit a payment from the user's payment account to the merchant's payment account. In an embodiment of the invention, registering the merchant for automated bill payment may include the further step of notifying the merchant of the registration, with instructions that future bills be raised on the user through the payment institution.

Subsequently at step 208, the merchant provides the user 102 with goods or services, and charges the user for such goods or services, by billing the user. In an embodiment where the merchant has been informed that it has been registered by the user 102 for automated bill payments through payment institution 106, the merchant may transmit its bill directly to the payment institution. In another embodiment, the merchant may transmit its bill to the user 102 or to an electronic account associated with the user 102, and which bill may thereafter be redirected for payment to the payment institution 106.

Thereafter at step 210, responsive to determining that the charges itemized by the merchant in the bill are authorized by the user, payment institution server 106a initiates an electronic payment transaction transferring the charged amount to the merchant payment account and simultaneously deducting the charged amount (and optionally a transaction fee) from the user's payment account that is maintained with payment institution 106. The step of determining that the charges raised by the merchant are authorized for payment may be implemented in multiple ways. In one, the user 102 is notified of said charge, and the payment institution 106 may require the user to transmit an authorization instruction to the payment institution 106 before initiating the electronic payment to a merchant account 110. In another, the payment institution 106 determines whether the charges raised by the merchant are acceptable or consistent with one or more payment restrictions or payment rules that have specified by the user 102 at the time of registering the merchant for automated bill payments. In a particular embodiment, the payment institution 106 may only initiate an electronic payment to a merchant account 110 responsive to detection of one or more payment events or payment triggers that have been specified by the user 102 at the time of registering such merchant for automated bill payments.

As illustrated in the system 100 of FIG. 1, each user 102 may register a plurality of merchant accounts (merchant accounts 1 to n) for automated bill payments through payment institution 106.

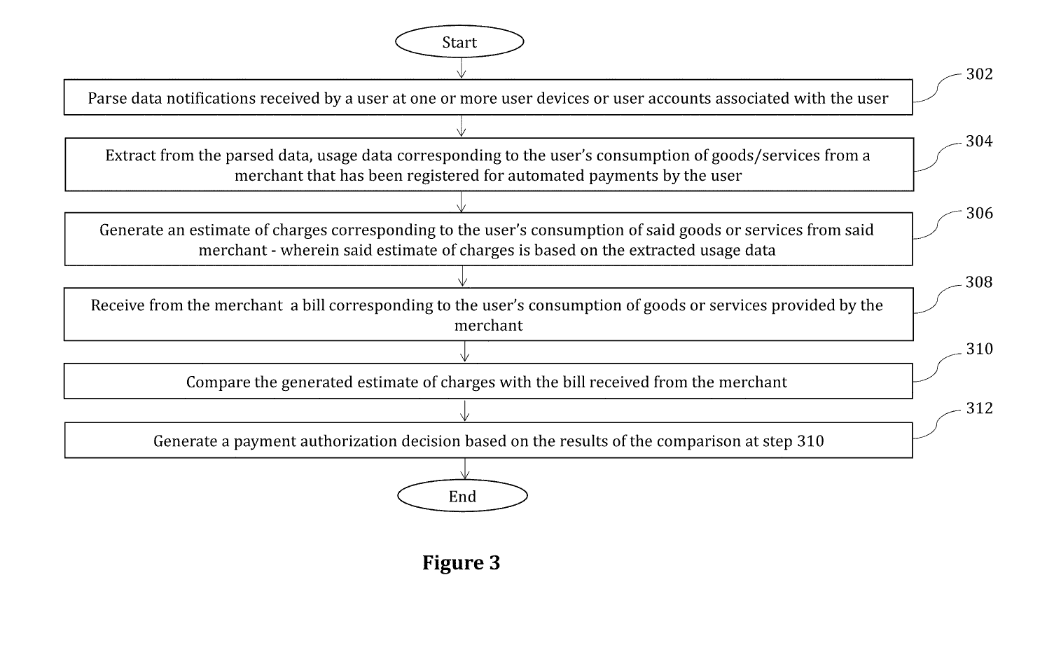

FIG. 3 illustrates a method in accordance with the present invention for enabling verification of charges levied by a merchant prior to authorizing payment of the merchant charges through the automated bill payment system. The method of FIG. 3 relies on (a) extraction, identification and interpretation of electronic data that are received by a user and which are descriptive of the goods or services consumed by said user, (b) correlating said data with one or more merchants that have been registered by the user for automated bill payment, and (c) using such data to verify the bills that have been generated by such merchants for the purposes of receiving automated bill payments in accordance with the methods discussed generally in connection with FIG. 2.

The method of FIG. 3 relies on the practice wherein merchants and service providers provide regular updates or update related data notifications to a user over a user device (such as through short-message-service (SMS) communications sent to an electronic device associated with the user) or at an electronic address associated with the user (for example, at a registered email id associated with the user). The updates or update related data notifications typically contain transaction data corresponding to one or more transactions between the user and a merchant or service provider. For example, SMS notifications or email notifications may be sent by a merchant or service provider to a user (i) to inform the user of recently completed transactions (for example, informing the user about the goods or services provided, number of units provided, cost associated with the transaction, and any credits, debits, purchases, refunds etc.) between the user on the one hand and the merchant or service provider on the other, (ii) or to remind the user of upcoming transactions, such as transaction dates, transaction amounts, transaction types, goods or services involved in the transactions and/or balances associated with any such upcoming transactions.

Since electronic communications such as SMS communications or email communications or other electronic data notifications of types discussed in the preceding paragraphs are easily transmitted through widely available communication networks (e.g. cellular networks or internet protocol based networks) with low costs and low impact on network bandwidths, such notifications are regularly used as reliable, cheap, lightweight, timely and accessible mechanisms for alerting a user/consumer of goods or services regarding provision or consumption of said goods or services. For example, a user may receive a notification within a few seconds to a few minutes after a transaction event or a service event, or a billing event—for the purpose of notifying the user of such event, and thereby enabling the user to track consumption and also detect fraudulent transactions or unauthorized or fraudulent events. The present invention utilizes such data notifications by parsing the data notifications, extracting and analyzing data from the data notifications, and using such data for the purposes of verifying a bill, received from a particular merchant or service provider for accuracy or correctness, prior to authorizing automated bill payment of said bill.

Step 302 of FIG. 3 comprises parsing update related data notifications received by a user at one or more user devices or user accounts associated with the user. The parsed data notifications may include any one or more of SMS notifications, email notifications, messenger application notifications, pop-up alert notifications, or any other electronic data notifications.

Step 304 comprises extracting from the parsed data notifications, usage data corresponding to the user's consumption of goods or services from a merchant who has been approved or registered by the user for the purposes of automated bill payments. The step of determining whether a specific data notification corresponds to a merchant that has been approved or registered for automated bill payments may include analysis and comparison of data within each data notification with merchant information retrieved from a payment institution database that has been configured to store merchant information corresponding to approved or registered merchants. In various embodiments, the determination of step 304 may include lexical analysis of the parsed data. In an embodiment of the invention, in addition to extracting usage data, step 304 may include extraction of price data corresponding to the goods or services to which the parsed data notifications relate. In embodiments where step 304 includes extraction of price data, the price data extracted from a data notification may additionally be associated or linked with the usage data extracted from said data notification.

Step 306 involves generating an estimate of charges corresponding to the user's consumption of goods or services from said merchant—wherein generation of said estimate of charges is based on the consumption of goods or services that has been determined at step 304. In an embodiment of the invention, generation of the estimate of charges is additionally based on price data related to the consumed goods or services—which price data may have been extracted (at step 304) from data notifications received by the user, or alternatively may have been retrieved from one or more price data repositories made available by the concerned merchant (for example, price data retrieved from a webpage or web site of the merchant).

In a particular embodiment, generating the estimate of charges at step 306 may comprise aggregating usage data and/or price data corresponding to a particular merchant, and using the aggregated data to generate an “aggregated” bill reflecting the consolidated charges incurred by a user towards goods or services received from a merchant across multiple transactions (for example, over a period of a day, week, month or year).

Step 308 thereafter comprises receiving from the merchant, a bill corresponding to the user's usage or consumption of goods or services provided by a merchant.

At step 310, the bill received from the merchant is compared with the estimate of charges generated at step 306. In an embodiment, the comparison at step 310 comprises determining whether there is a variance between the bill received from the merchant and the estimate of charges generated at step 306. At step 312, a payment authorization decision is generated based on the results of the comparison at step 310—wherein depending on whether a variance is found between the bill received from the merchant and the estimate of charges generated at step 306 (and optionally depending on the magnitude of any detected variance), the automated bill payment to the merchant may either be authorized or refused.

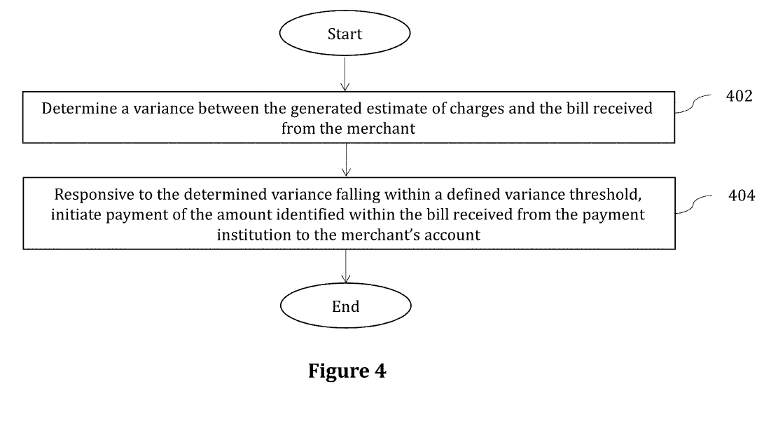

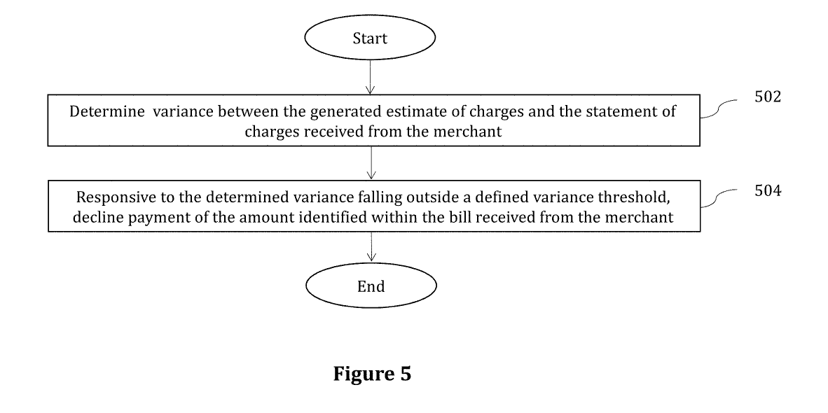

FIGS. 4 and 5 illustrate specific embodiments of steps 310 and 312 of FIG. 3.

As illustrated in FIG. 4, step 402 comprises the step of determining a variance between an estimate of charges (of the type generated at step 306 of FIG. 3) and a bill received from a merchant (of the type received at step 308 of FIG. 3). It would be understood that the variance may comprise a zero value or any value that reflects the difference between the two charges. At step 404, responsive to the determined variance falling within a defined variance threshold (i.e. the determined variance being less than a defined limit of permissible variance), the amount identified within the merchant's bill is paid by the payment institution into the merchant's payment account. It would be understood that the defined variance threshold may comprise any maximum permissible variance value, and in an embodiment, may comprise a user or administrator defined value.

In FIG. 5, step 502 comprises the step of determining a variance between an estimate of charges (of the type generated at step 306 of FIG. 3) and a bill received from a merchant (of the type received at step 308 of FIG. 3). It would be understood that the variance may comprise a zero value or any value that reflects the difference between the two charges. At step 504, responsive to the determined variance falling outside a defined variance threshold (i.e. the determined variance being greater than a defined limit of permissible variance), the payment institution declines automated payment of the amount identified in the merchant's bill into the merchant's payment account. It would once again be understood that the defined variance threshold may comprise any maximum permissible variance value, and in an embodiment, may comprise a user or administrator defined value.

It would further be understood that there are various possible alternatives to the methods of FIGS. 4 and 5. In one alternative to the methods of FIG. 4 or 5, responsive to the determination of variance (at steps 402 of 502), the method may not immediately either make the payment or decline payment to the merchant, and may instead involve alerting the user of the detected variance and seeking a prior verification instruction from the user before making or declining the payment.

In addition to the embodiments discussed above, the invention additionally provides safeguards to ensure that automated payments to a merchant can be modified, terminated or suspended in response to modification, termination or suspension of the merchant's contract for providing goods or services to a user.

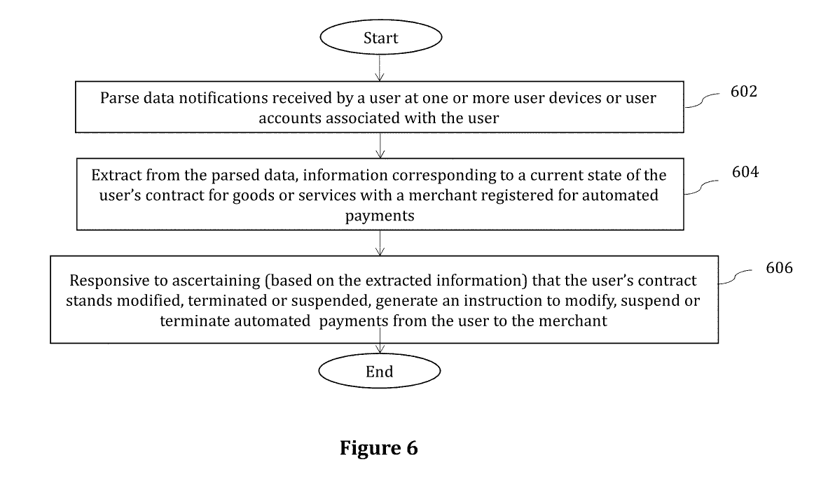

FIG. 6 illustrates a method embodiment configured for achieving this objective. The method of FIG. 6 comprises a method for updating an enrollment state of a merchant that has been previously enrolled for automated bill payments by a user.

The method of FIG. 6 relies on the practice of merchants and service providers to provide update related data notifications to a user at a user device or at an electronic address associated with the user, in response to changes or modifications to an existing contract for goods or services with a particular merchant. For example, a service provider may provide data notifications to a user at any or all of the following event milestones—(I) commencement of a contract for delivery of goods or services to the user, (ii) modification of an earlier contract for delivery of goods or services to a user, (iii) modification of prices or rates in connection with a pre-existing contract for delivery of goods or services to a user, (iv) merchant initiated modification, suspension or cancellation of a contract for delivery of goods or services to the user, or (v) user initiated modification, suspension or cancellation of a contract for delivery of goods or services to the user. The present invention utilizes such data notifications, by parsing such data, analyzing said data notifications, and using information extracted from such data notifications for the purposes of providing safeguards to ensure that automated payments to a merchant can be modified, terminated or suspended in response to modification, termination or suspension of the merchant's contract for providing goods or services to a user.

Step 602 of FIG. 6 comprises parsing update related data notifications received by a user at one or more user devices or user accounts associated with the user. The parsed data notifications may include any one or more of SMS notifications, email notifications, messenger application notifications, pop-up alert notifications, or any other type of data notifications.

Step 604 comprises extracting from the parsed data notifications, information corresponding to the current state of the user's contract for goods or services with a merchant who has been approved or registered by the user for the purposes of automated bill payments. The step of determining the current state of the user's contract from the parsed data may in an embodiment include analysis of data within each data notification—and further, may be based on merchant information retrieved from a payment institution database that has been configured to store merchant information corresponding to merchants that have been approved or registered by the user for automated bill payments. The determination of step 604 may additionally include lexical analysis of the parsed data to determine the current state of the user's contract based on the parsed data.

In an embodiment of the invention, the determination of step 604 may include ascertaining based on the parsed data notifications, whether any of the following events have occurred—(I) commencement of a contract for delivery of goods or services to the user, (ii) modification of an earlier contract for delivery of goods or services to a user, (iii) modification of prices or rates in connection with a pre-existing contract for delivery of goods or services to a user, (iv) merchant initiated modification, suspension or cancellation of a contract for delivery of goods or services to the user, or (v) user initiated modification, suspension or cancellation of a contract for delivery of goods or services to the user. It would be understood that the determination of step 604 may involve comparing a current state of the user's contract with a previously detected or identified state(s) of the user's contract—which previous state(s) may be stored and retrieved from a data repository configured to serve as data historian for state of the user's contract. In an embodiment, the determination of step 604 may involve comparing a current state of the user's contract with a state of the user's contract that has been detected or identified immediately prior to detection or identification of the current state.

At step 606, responsive to ascertaining that the user's contract with the merchant stands modified, the method comprises generating and transmitting an instruction to the payment institution server to update a state of the merchant's enrollment for automated bill payments. In an embodiment, the transmitted instruction to the payment server for updating a state of the merchant's enrollment for automated bill payments comprises an instruction for any one of modifying, suspending or terminate automated bill payments in connection with bills raised by said merchant on the user. It would be understood that (a) determining that the user's contract stands modified may result in generation and transmission of an instruction to the payment institution server to correspondingly modify the instructions for automated payment of bills raised by said merchant on the user, (b) a determination that the user's contract stands suspended may result in generation and transmission of an instruction to the payment institution server to correspondingly suspend automated payment of bills raised by said merchant on the user, and (c) a determination that the user's contract stands terminated may result in generation and transmission of an instruction to the payment institution server to correspondingly terminate automated payment of bills raised by said merchant on the user.

It would be understood that attributes of the instruction to the payment institution server to correspondingly modify, suspend or terminate automated bill payments in connection with bills raised by said merchant on the user, may be selected based on (i) one or more predefined rules regarding generation of instructions for updating a state of the merchant's enrollment for automated bill payments and/or (ii) the attributes of the detected change of state (i.e. the attributes of the modification, suspension or termination of the user's contract with the merchant)—as determined based on the analysis at step 604.

In various embodiments, the invention additionally comprises a computer program product comprising a non-transitory computer readable medium having a computer readable program code embodiment therein—said computer readable program code comprising instructions for implementation of any of the method embodiments described above.

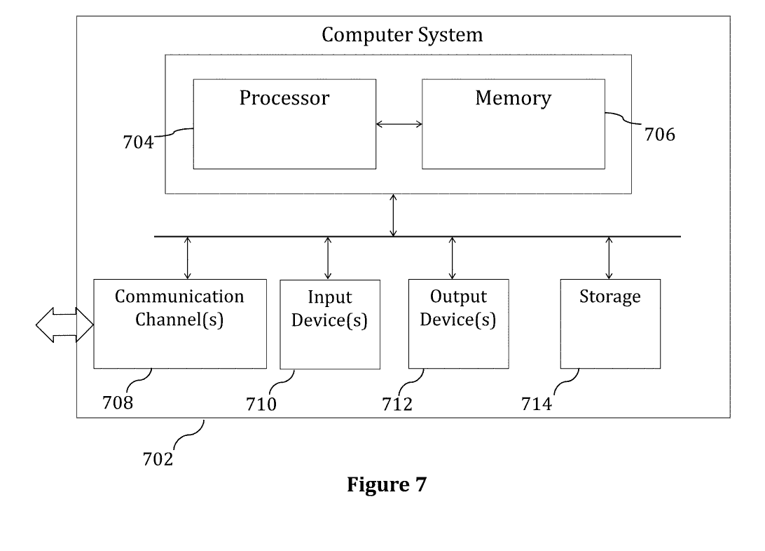

FIG. 7 illustrates an exemplary computer system 702 for implementing the present invention.

Computer system 702 comprises one or more processors 704 and at least one memory 706. Processor 704 is configured to execute program instructions—and may be a real processor or a virtual processor. It will be understood that computer system 702 does not suggest any limitation as to scope of use or functionality of described embodiments. The computer system 702 may include, but is not be limited to, one or more of a general-purpose computer, a programmed microprocessor, a micro-controller, an integrated circuit, and other devices or arrangements of devices that are capable of implementing the steps that constitute the methods of the present invention. Exemplary embodiments of a computer system 702 in accordance with the present invention may include one or more servers, desktops, laptops, tablets, smart phones, mobile phones, mobile communication devices, tablets, phablets and personal digital assistants. In an embodiment of the present invention, the memory 706 may store software for implementing various embodiments of the present invention. The computer system 702 may have additional components. For example, the computer system 702 may include one or more communication channels 708, one or more input devices 710, one or more output devices 712, and storage 714. An interconnection mechanism (not shown) such as a bus, controller, or network, interconnects the components of the computer system 702. In various embodiments of the present invention, operating system software (not shown) provides an operating environment for various software(s) executing in the computer system 702 using a processor 704, and manages different functionalities of the components of the computer system 702.

The communication channel(s) 708 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 710 may include, but is not limited to, a touch screen, a keyboard, mouse, pen, joystick, trackball, a voice device, a scanning device, or any another device that is capable of providing input to the computer system 702. In an embodiment of the present invention, the input device(s) 710 may be a sound card or similar device that accepts audio input in analog or digital form. The output device(s) 712 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 702.

The storage 714 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 702. In various embodiments of the present invention, the storage 714 may contain program instructions for implementing any of the described embodiments.

In an embodiment of the present invention, the computer system 702 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 702. The method described herein is typically implemented as a computer program product, comprising a set of program instructions that is executed by the computer system 702 or any other similar device. The set of program instructions may be a series of computer readable codes stored on a tangible medium, such as a computer readable storage medium (storage 714), for example, diskette, CD-ROM, ROM, flash drives or hard disk, or transmittable to the computer system 702, via a modem or other interface device, over either a tangible medium, including but not limited to optical or analogue communications channel(s) 708. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

What is claimed is:

1. A method for automated payment of bills comprising:
parsing one or more data notifications received by a user from a merchant that has been enrolled by the user for automated bill payment;
extracting from the parsed data notifications, data describing goods or services provided by the merchant to the user;
generating an estimate of charges based on the extracted data;
receiving a bill of charges from the merchant;
determining a variance between the generated estimate of charges and charges identified in a bill received from the merchant; and
generating a payment authorization decision corresponding to the bill received from the merchant, wherein the payment authorization decision is based on the determined variance.

2. The method as claimed in claim 1, wherein responsive to the determined variance falling within a defined variance threshold, the payment authorization decision comprises a decision to initiate payment of a due amount identified within the bill received from the merchant.

3. The method as claimed in claim 1, wherein responsive to the determined variance falling outside a defined variance threshold, the payment authorization decision comprises a decision to decline payment of a due amount identified within the bill received from the merchant.

4. The method as claimed in claim 1, wherein responsive to the determined variance falling outside a defined variance threshold, the payment authorization decision comprises a decision to transmit a request for payment authorization to the user.

5. A method for updating an enrollment state of a merchant that has been enrolled for automated bill payments by a user:
parsing one or more data notifications received by the user from the merchant;
extracting from the parsed data notifications, data describing a present state of a contract for goods or services between the user and the merchant;
analyzing the extracted data for detecting a change in state of the contract, wherein detection of change in state is based on comparing a detected present state of the contract with an earlier identified state of the contract;
responsive to detecting a change in state of the contract, generating an instruction to update a state of the merchant's enrollment for automated bill payments.

6. The method as claimed in claim 5, wherein responsive to the detected change in state of the contract comprising a modification to the state of the contract, the generated instruction to update a state of the merchant's enrollment for automated bill payments comprises an instruction to modify said state of the merchant's enrollment for automated bill payments.

7. The method as claimed in claim 5, wherein responsive to the detected change in state of the contract comprising suspension of the contract, the generated instruction to update a state of the merchant's enrollment for automated bill payments comprises an instruction to suspend the merchant's enrollment for automated bill payments.

8. The method as claimed in claim 5, wherein responsive to the detected change in state of the contract comprising termination of the contract, the generated instruction to update a state of the merchant's enrollment for automated bill payments comprises an instruction to terminate the merchant's enrollment for automated bill payments.

9. The method as claimed in claim 5, wherein attributes of the generated instruction to update a state of the merchant's enrollment for automated bill payments are based on (i) one or more predefined rules regarding generation of instructions for modification, suspension or termination of prior instructions for automated bill payment or (ii) the attributes of the detected change of state of the merchant's enrollment for automated bill payments.

10. A computer implemented system for automated payment of bills, comprising:
a processor configured to:
parse one or more data notifications received by a user from a merchant that has been enrolled by the user for automated bill payment;
extract from the parsed data notifications, data describing goods or services provided by the merchant to the user;
generate an estimate of charges based on the extracted data;
receive a bill of charges from the merchant;
determine a variance between the generated estimate of charges and charges identified in a bill received from the merchant; and
generate a payment authorization decision corresponding to the bill received from the merchant, wherein the payment authorization decision is based on the determined variance.

11. The computer implemented system as claimed in claim 10, wherein the processor is configured such that, responsive to the determined variance falling within a defined variance threshold, the payment authorization decision comprises a decision to initiate payment of a due amount identified within the bill received from the merchant.

12. The computer implemented system as claimed in claim 10, wherein the processor is configured such that, responsive to the determined variance falling outside a defined variance threshold, the payment authorization decision comprises a decision to decline payment of a due amount identified within the bill received from the merchant.

13. The computer implemented system as claimed in claim 10, wherein the processor is configured such that responsive to the determined variance falling outside a defined variance threshold, the payment authorization decision comprises a decision to transmit a request for payment authorization to the user.

14. A computer implemented system for updating an enrollment state of a merchant that has been enrolled for automated bill payments by a user, comprising:
a processor configured to:
parse one or more data notifications received by the user from the merchant;
extract from the parsed data notifications, data describing a present state of a contract for goods or services between the user and the merchant;
analyze the extracted data for detecting a change in state of the contract, wherein detection of change in state is based on comparing a detected present state of the contract with an earlier identified state of the contract;
responsive to detecting a change in state of the contract, generate an instruction to update a state of the merchant's enrollment for automated bill payments.

15. The computer implemented system as claimed in claim 14, wherein the processor is configured such that, responsive to the detected change in state of the contract comprising a modification to the state of the contract, the generated instruction to update a state of the merchant's enrollment for automated bill payments comprises an instruction to modify said state of the merchant's enrollment for automated bill payments.

16. The computer implemented system as claimed in claim 14, wherein the processor is configured such that, responsive to the detected change in state of the contract comprising suspension of the contract, the generated instruction to update a state of the merchant's enrollment for automated bill payments comprises an instruction to suspend the merchant's enrollment for automated bill payments.

17. The computer implemented system as claimed in claim 14, wherein the processor is configured such that, responsive to the detected change in state of the contract comprising termination of the contract, the generated instruction to update a state of the merchant's enrollment for automated bill payments comprises an instruction to terminate the merchant's enrollment for automated bill payments.

18. The computer implemented system as claimed in claim 14, wherein the processor is configured such that, attributes of the generated instruction to update a state of the merchant's enrollment for automated bill payments are based on (i) one or more predefined rules regarding generation of instructions for modification, suspension or termination of prior instructions for automated bill payment, or (ii) the attributes of the detected change of state of the merchant's enrollment for automated bill payments.

19. A computer program product for automated payment of bills, comprising a non-transitory computer readable medium having a computer readable program code embodiment therein, the computer readable program code comprising instructions for:
parsing one or more data notifications received by a user from a merchant that has been enrolled by the user for automated bill payment;
extracting from the parsed data notifications, data describing goods or services provided by the merchant to the user;
generating an estimate of charges based on the extracted data;
receiving a bill of charges from the merchant;
determining a variance between the generated estimate of charges and charges identified in a bill received from the merchant; and
generating a payment authorization decision corresponding to the bill received from the merchant, wherein the payment authorization decision is based on the determined variance.

20. A computer program product for updating an enrollment state of a merchant that has been enrolled for automated bill payments by a user, comprising a non-transitory computer readable medium having a computer readable program code embodiment therein, the computer readable program code comprising instructions for:
parsing one or more data notifications received by the user from the merchant;
extracting from the parsed data notifications, data describing a present state of a contract for goods or services between the user and the merchant;
analyzing the extracted data for detecting a change in state of the contract, wherein detection of change in state is based on comparing a detected present state of the contract with an earlier identified state of the contract;
responsive to detecting a change in state of the contract, generating an instruction to update a state of the merchant's enrollment for automated bill payments.
